(19) United States
(12) Patent Application Publication
(10) Pub. No.: US 2010/0092595 A1
(43) Pub. Date: Apr. 15, 2010

(54) HOT-RUNNER NOZZLE WITH TEMPERATURE SENSOR

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 12/448,063

(22) PCT Filed: Oct. 31, 2007
(86) PCT No.: PCT/EP2007/009491

§ 371 Date: Jun. 5, 2009

(30) Foreign Application Priority Data
Dec. 6, 2006 (DE) 20 2006 018 576.3

(51) Int. Cl. B29C 47/92

(52) U.S. Cl. 425/170

(57) ABSTRACT

An injection molding hot runner nozzle (30) comprises a material feed pipe (32) containing at least one flow duct (40) for a fluid feed material, further a muff (10) which can be slipped onto said pipe, a heater (16) to warm said feed pipe and a temperature sensor (20). In order to very accurately detect the temperature of the fluid material passing through the feed pipe, the invention prescribes that the muff (10) be fitted with a feedthrough (24) which substantially runs radially through a wall of said muff and into which is guided a free end of the temperature sensor (20), or a temperature sensor segment (56) configured near said free end, when the muff (10) has been slipped onto the material feed pipe (32).

The present invention relates to a hot-runner nozzle used in an injection mold and defined in the preamble of claim 1.

Hot runner nozzles are used in injection molds to feed a fluid material being processed such as a plastic melt at a predetermined temperature and high pressure to a separable mold insert. Most nozzles comprise a material feed pipe fitted with a flow duct issuing into a nozzle mouth element. Said elements subtends a terminal nozzle discharge aperture issuing through a gate in the mold insert (mold nest). A heater is used to prevent the fluid processing material from prematurely cooling within the material feed pipe and must assure as uniform as possible a temperature distribution as far as into said nozzle mouth element. A thermal insulator between the hot nozzle and the cold mold prevents the nozzle from freezing and the mold, respectively the mold insert, from heating.

Because the plastics being processed frequently have a very narrow processing window and respond very strongly to temperature fluctuations, high requirements are set on is the temperature control of the hot runner nozzle. Illustratively a change in temperature of a few degrees may entail injection defects and wastes. Accurate temperature control therefore matters greatly if a hot runner mold is to run and be fully automated.

Also it is important as regards multi-cavity injection molds—for instance fitted with 24, 32 or 64 cavities—that the setpoint temperature shall be the same for all molding nests. Accordingly the setpoint temperature must agree very precisely with the actual nozzle temperature.

Typically temperature sensors are used to monitor the temperature. The temperature sensor output signals then may be fed to an appropriate temperature control operating by reference/instantaneous-temperature compensation.

A hot runner nozzle for an injection mold is illustratively described in the European patent document EP 623 810 A1. As regards said nozzle, a thermally conducting muff is slipped onto the material feed pipe, this muff being fitted with an elongated slot receiving a temperature sensor. A clamping bush is configured underneath the thermally conducting muff and comprises at its inside a recess externally accessible through a conduit. The free end of the temperature sensor passes through the conduit into the recess, and thereupon the clamping muff is rotated on the material feed pipe and the free temperature sensor end is kept affixed in the clamping bush. This design incurs the drawback that, in addition to the thermally conducting muff, another component in the form of the clamping bush must be included; this feature is undesirable both regarding the hot runner nozzle manufacture and its assembly.

Based on the above state of the art, one object of the present invention is to create an injection mold hot runner nozzle fitted with a temperature sensor but of a different design to remedy at least in part the above cited problems.

Accordingly the present invention offers an injection mold hot runner nozzle defined in claim 1. The dependent claims relate to particular embodiments of the present invention.

The hot runner nozzle of the present invention comprises a material-feed pipe preferably made of steel, at least one flow duct for a fluid material to be processed being subtended in said pipe. The hot runner nozzle of the present invention includes a preferably thermally conducting muff illustratively made of copper or a copper alloy which is slipped onto said pipe. The present invention furthermore includes a heater to warm said pipe and a temperature sensor.

In the present invention, the hot runner nozzle muff comprises a feedthrough running substantially radially through a muff wall and allowing externally accessing respectively seeing the said pipe when the muff has been slipped onto it. A free end of the temperature sensor constituting its measuring point, or a corresponding sensor segment near the free sensor in the state of the muff being situated on the material feed pipe, is configured in, and/or passes through, said feedthrough. Accordingly the feedthrough subtends a free space between the material feed pipe, the muff and the temperature sensor, as a result of which the temperature sensor's measurement is out of direct contact with the thermally conducting muff. Therefore the heat dissipated by the heater cannot directly affect the temperature sensor respectively its measuring tip. In this manner said tip is able to measure the material feed pipe's temperature and hence the temperature of the melt therein much is more accurately, that is, the outer region's temperature picked up by the temperature sensor much more accurately represents the melt temperature in the material feed pipe.

The above discussed design of the hot runner nozzle of the present invention is also advantageous in that it is very simple and requires very few parts. Moreover the temperature sensor can be exchanged, together with muff and heater, in very simple manner.

Preferably at least one groove is fitted into and along the muff's outside surface to receive the heater and/or the temperature sensor. In a particular embodiment mode of the present invention, the muff's outer surface is fitted both with a groove receiving the heater and another groove receiving the temperature sensor. In this way the heater and the temperature sensor are integrated into the muff, this feature proving very advantageous in particular when mounting/assembling the hot runner nozzle of the present invention.

To affix the heater and/or the temperature sensor to the muff, said components preferably can be press-fitted into the particular groove. Alternatively the heater and the temperature sensor may be bonded, soldered or affixed in another way into the muff.

In one variation of the hot runner nozzle of the present invention, the feedthrough fitted into the muff is comprises at its outside surface a groove or a slot-shaped extension in a manner that the free temperature sensor end acting as the measurement point is affixed in said extension, such affixation being implemented by press-fitting, soldering or bonding or the like. Due to this affixation, the temperature sensor measuring segment will always be affixed in a way that said sensor's detection point, which is near its free end, shall be immobile even under extreme external conditions. Because of the constant positions between the temperature sensor and the heater, the material feed pipe temperature is always duly picked up.

Alternatively a free temperature sensor end may project in defined manner into the feedthrough. The free temperature sensor end advantageously shall be affixed by a holding element which when integrated assures contact between the free end of said sensor and the material feed pipe. Preferably the holding element is a clamp made of a spring steel resistant to heat up to about 500° C.

In a further alternative embodiment of the present invention, the free temperature sensor end also may be guided through the muffs feedthrough and be received in a recess subtended in such manner in an external surface of the material feed pipe and/or in an inside surface of the muff that, once the muff has been slipped onto the material feed pipe, said recess shall communicate with said feedthrough. Said free end then can be affixed into said recess by press-fitting, bonding, soldering or the like, thereby ensuring again a constant position of the temperature sensor's temperature measuring segment even in the event of extreme external conditions.

The invention is elucidated below by illustrative embodiment modes of its hot runner nozzle and in relation to the appended drawing.

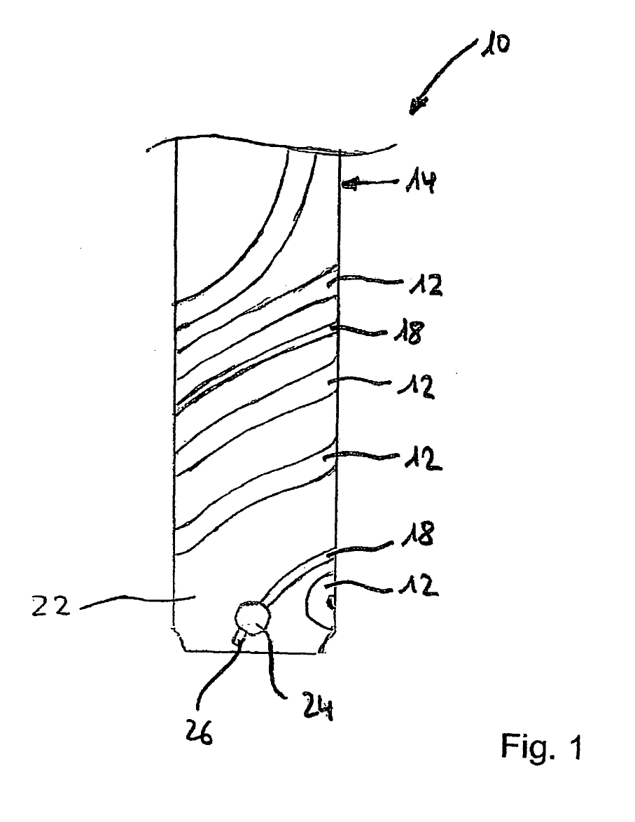

FIG. 1 is a view of a first embodiment mode of a muff of the hot runner nozzle of the present invention,

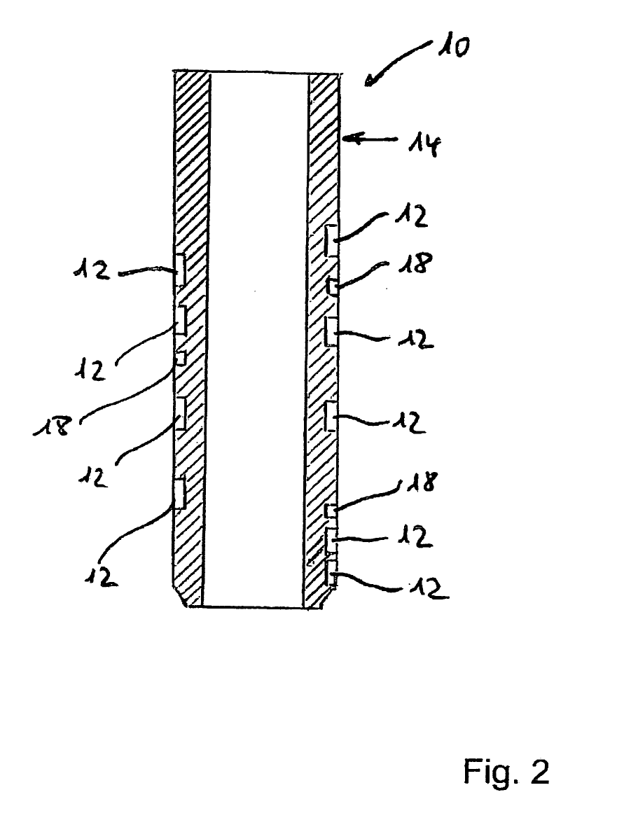

FIG. 2 is a sectional elevation of the muff shown in FIG. 1,

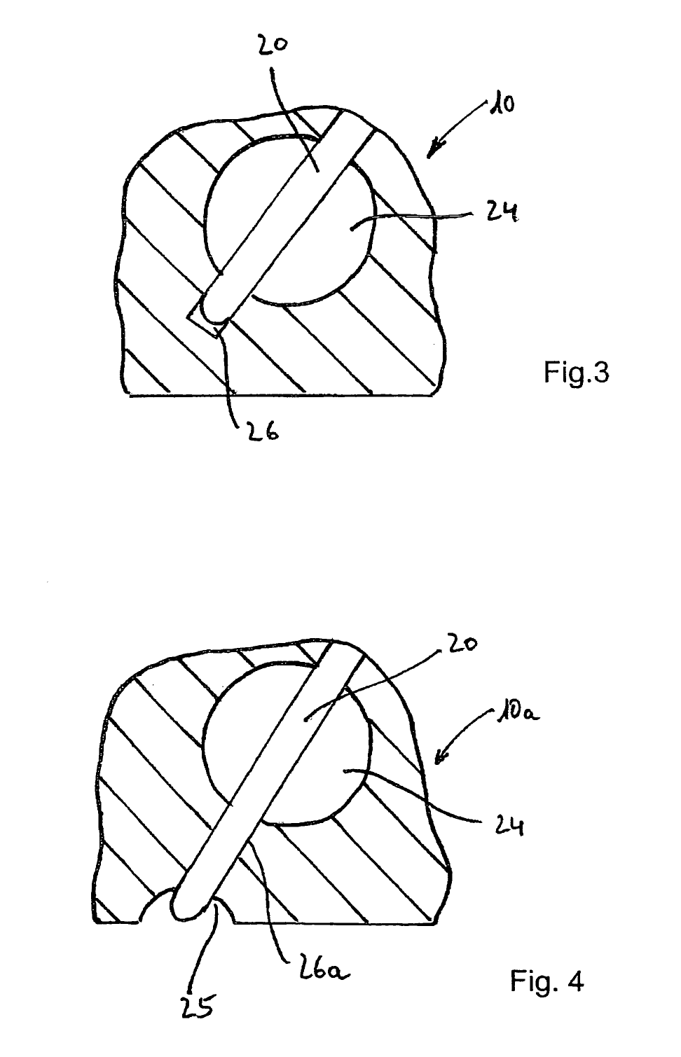

FIG. 3 is an enlarged partial elevation of the muff of FIGS. 1 and 2 with inserted temperature sensor,

FIG. 4 is an enlarged partial elevation similar to that of FIG. 3 of an alternative embodiment mode of a muff of the hot runner nozzle of the invention with inserted temperature sensor,

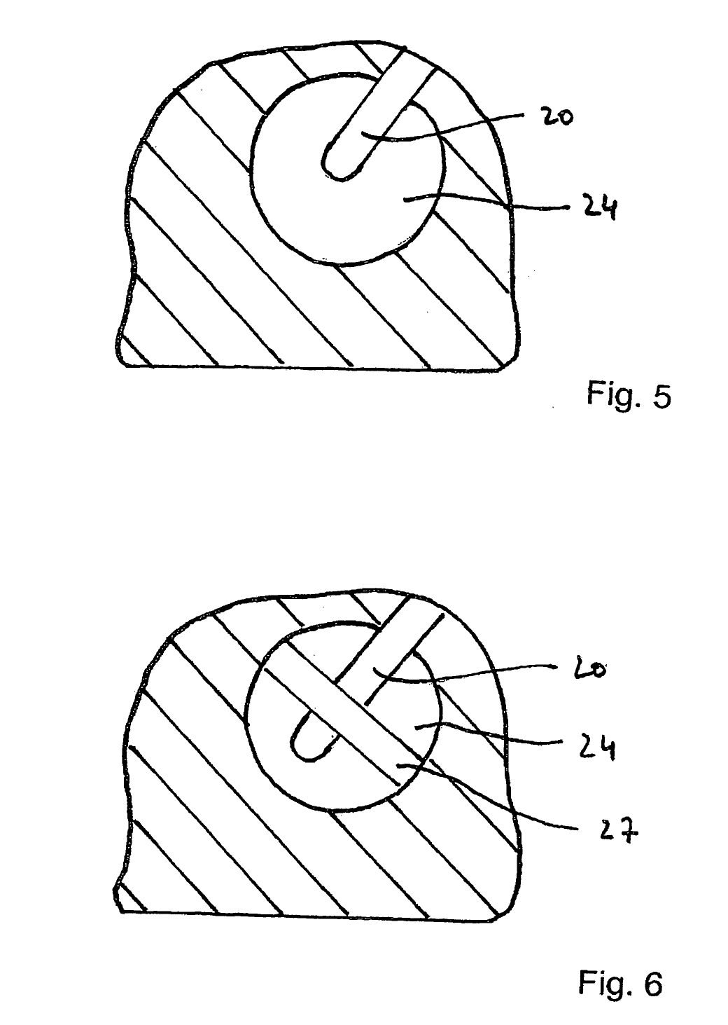

FIG. 5 is an enlarged partial elevation similar to that of FIG. 3 of another alternative embodiment mode of a muff of the hot runner nozzle of the invention with inserted temperature sensor,

FIG. 6 is an enlarged partial elevation similar to that of FIG. 3 of the muff of the invention with inserted temperature sensor,

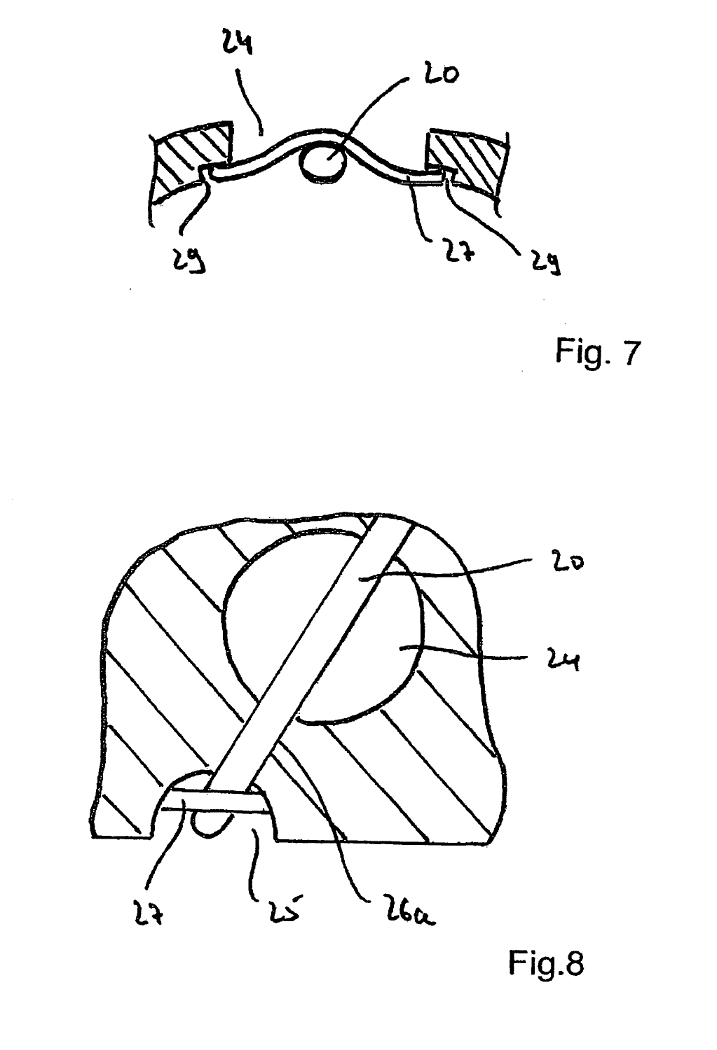

FIG. 7 is a partial cross-section of the embodiment mode of FIG. 6 of a muff of the hot runner nozzle of the invention with inserted temperature sensor,

FIG. 8 is an enlarged partial elevation of yet another alternative embodiment mode of a muff of the hot runner nozzle of the invention with inserted temperature sensor, and

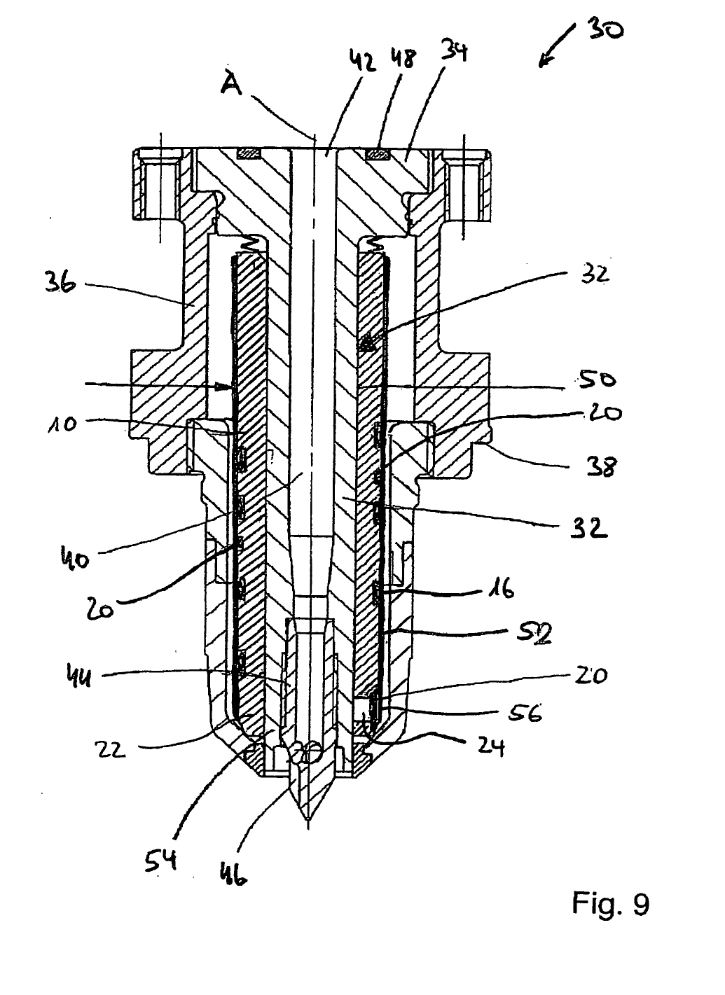

FIG. 9 is a sectional elevation of a hot runner nozzle of the invention fitted with the muff shown in FIGS. 1 and 2.

Identical reference numerals below relate to identical components.

The design of one embodiment of a hot runner nozzle of the invention is elucidated below in relation muff 10 in relation to FIGS. 1, 2, 3 and 7, FIG. 1 being a front view of the muff 10, FIG. 2 a sectional elevation of said muff, FIG. 3 an enlarged elevation of the muff 10 and FIG. 9 a sectional elevation of said muff when integrated into a hot runner nozzle.

The muff 10 is substantially tubular and made of thermally well conducting substance such as copper, a copper alloy or the like.

An approximately helical groove 12 is axially fitted into the outer surface 14 of the muff 10 and receives a filamentary heater 16 as indicated in FIG. 9. The filamentary heater 16 is affixed by press-fitting or similar into the groove 12, though it also may be affixed into it by bonding, soldering or the like. Another groove 18 is fitted into the outer surface 14 of the muff 10 and also runs axially and helically along the muff 10. This second groove 18 receives a filamentary temperature sensor 20 as shown in FIG. 9. A feedthrough 24 in the form of a borehole is fitted into an end segment 22 of the muff 10 and runs substantially radially inward from the outer surface 14 of said muff through its wall. The groove 18 receiving the temperature sensor 20 issues into said feedthrough.

A groove-shaped extension 26 is subtended substantially opposite the end of the groove 18 issuing into the feedthrough 24 and—in the configuration of the temperature sensor 20 being received in the groove 18—receives the free sensor end, as shown in the enlarged partial elevation of FIG. 3. In this design the free end of the temperature sensor 20 is clamped into the extension. Alternatively said free end also may be affixed for instance by bonding, soldering or the like in said extension. Accordingly, when the temperature sensor 20 is inserted into the groove 18, a segment near its end will pass through the feedthrough 24.

Furthermore boreholes not shown in the Figures may be present which can be entered by a removing tool to facilitate in particular the disassembly of the muff 10 from the material feed pipe 32.

FIGS. 4 through 8 show alternative embodiment modes of the muff of the hot runner nozzle of the invention.

As shown by FIG. 4, a groove-shaped extension 26a is subtended at the feedthrough 24 at the end of the groove 12 opposite the end of the groove 18 issuing into said feedthrough and runs as far as the lower end of the muff 10a, issuing into recess 25 subtended in the free end of the muff 10a. The free end of the temperature sensor 20 is clamped into the groove-shaped extension 26a, said free sensor end entering the recess 25. Alternatively the free temperature sensor end also may be affixed in the extension 26a by bonding, soldering or the like. In this embodiment mode the temperature sensor 20 is situated nearer the free end of the material feed pipe 32 without thereby lengthening the sub-assembly muff 10 and heater 16 and without the free end of said temperature sensor projecting from, respectively out of, the muff.

In the embodiment mode of FIG. 5, the free end of the temperature sensor 20 projects from the end of the groove 18 issuing into the feedthrough 24 in a defined manner into said feedthrough where it terminates.

As shown in FIG. 6, free end of the temperature sensor 20 projects in defined manner from the end of the groove 18 issuing into the feedthrough 24 wherein it terminates, the temperature sensor free end being kept in place using a clamp 27 in a way to assure contact between the temperature sensor's free end and the material feed pipe 32. This object is attained in the present embodiment in that—as more explicitly seen in the cross-sectional view of FIG. 7—the said clamp 27 acting as a depressing element presses the temperature sensor 20 down toward the omitted material feed pipe. In the process the free ends of the clamp 27 engage corresponding extension areas 29 of the feedthrough 24 for the purpose of affixing said clamp in the recess 24. The clamp 27 is made of a heat resistant spring steel (up to and higher than 500° C.), in order to generate the force required to press the free temperature sensor end against the material feed pipe.

FIG. 8 shows another embodiment mode similar to that of FIG. 4 except that in latter case the free end of the temperature sensor 20 is forced by a clamp 27 as indicated in FIGS. 6 and 7 toward the material feed pipe to attain contact between said temperature sensor and said pipe. The affixation principle used for the clamp 27 in the recess 25 in the embodiment of FIG. 8 corresponds to that shown in FIG. 7.

FIG. 9 shows a hot runner nozzle 30 into which is integrated the muff 10 shown in FIGS. 1 and 2. This hot runner nozzle 30 is designed for an injection mold. It comprises a material feed pipe 32 fitted at its upper end with a flange-shaped connection head 34. This head 34 is seated in detachable manner in a housing 36 which can be affixed from below to an omitted manifold plate. A radial offset 38 centers the housing 36, hence the hot runner nozzle 30, in the mold. A flow duct for a melt of processing material is fitted centrally within the material feed pipe 32 running in the axial direction A. The flow duct 40 preferably is a borehole comprises a processing material feed aperture 42 in the connection head 34 and issues at its lower end into a nozzle mouth element 44 illustratively designed as a nozzle tip. Said nozzle tip is fitted with a processing material discharge aperture 46 to feed a fluid melt of processing material into an omitted mold nest. The nozzle mouth element 44 preferably is made of a thermally highly conducting substance and is terminally inserted into the material feed pipe 32, preferably in threaded manner. However, depending on the application, and with its operation the same, said element 44 also may be supported in axially displaceable manner or be integral with said feed pipe. A sealing ring 48 is used to seal the hot runner nozzle 30 relative to the manifold plate and is configured in the connection head 34 of the material feed pipe 32 concentrically with the material feed aperture 42. Conceivably an additional (omitted) annular centering element might be used to facilitate the assembly of the hot runner nozzle 30 to the mold.

The muff 10 of FIGS. 1 and 2 is deposited on the outer circumference 50 of the material feed piper 32 and the filamentary heater 16 and the filamentary temperature sensor 20 are correspondingly affixed in the grooves 12, 18 of said muff. The particular terminals of the heater 16 and the temperature sensor 20 project laterally from the housing 36 (not shown). The entire muff 10 is enclosed by a sheath 52 slipped onto it.

The hot runner nozzles 30 is shown in its integrated state in FIG. 9 and the feedthrough 24 in the muff 10 is situated in the end region 54 of the material feed pipe 32 where the temperature of said pipe is detected. In this design the feedthrough 24 sets up direct communication between the circumferential surface 50 of the material feed pipe 32 and a segment 56 of the temperature sensor 20 situated in the said temperature sensor's free end affixed in the extension 26 of the feedthrough 24. On account of this direct communication the temperature detected by the sensor 20 is hardly or not at all affected or degraded by the temperature of the muff 10, the latter temperature differing from that of the material feed pipe 32, as a result of which the temperature sensor 20 is able to detect accurately the temperature of the said material feed pipe and hence that of the melt in it.

When exchanging the temperature sensor 20 or the heater 16, no more need be done than disassembling the muff 10 from the material feed pipe 32 and replacing it with is another muff fitted with a fixed temperature sensor and heater, such a procedure being implemented rapidly.

In an alternative embodiment mode of the muff of the hot runner nozzle of the present invention, the extension 26—which in the design of FIGS. 1 through 3 is fitted in the outer surface 14 of the muff 10—also may be selectively subtended at the muffs inside surface or at the material feed pipe's outer surface, though this option is not shown in said FIGS. 1 through 3. In this alternative embodiment mode, first the temperature sensor's end segment is moved through the feedthrough before the end of said sensor is inserted into it. Thereupon the temperature sensor may be affixed in said extension and/or between the muff and the material feed pipe. If the muff then is affixed for instance by press-fitting or by another force-fit to the material feed pipe, then the affixation of the temperature sensor's free end also may be implemented compressively between said components. In such a procedure the relative position of heater and material feed pipe is also set simultaneously.

In summary the design of the muff of the hot runner nozzle of the present invention is characterized by its simplicity. In such a design, additional components that otherwise would be required to affix said temperature sensor or the heater to the muff are eliminated. Such accurate and permanent configuration of temperature sensor and heater moreover allows optimal reproducibility of the temperature sensor data.

It should be borne in mind that the above described embodiment modes of the hot runner nozzle of the present invention do not entail or imply limitation in any way. Instead modifications and amendments may be resorted to without thereby transcending the scope of this invention as defined in the appended claim.

### LIST OF REFERENCES

A axial direction
10 muff
10a muff
12 groove
14 outside surface
16 heater
18 groove
20 temperature sensor
22 end segment
24 feedthrough
25 recess
26 extension
26a extension
27 clamp
30 hot runner nozzle
32 material feed pipe
34 connection head
36 housing
38 offset
40 flow duct
42 material feed aperture
48 sealing ring
50 outer circumference surface
52 sheath
54 end segment
56 portion

1. An injection mold hot runner nozzle (30) comprising a material feed pipe (32) fitted with at least one flow duct (40) passing a fluid material, further a muff (10; 10a) which can be slipped onto the material feed pipe (32), a heater (16) to warm the material feed pipe (32) and a temperature sensor (20), characterized
in that the muff (10; 10a) which is fitted near one of its end segments with a feedthrough (24) running substantially radially through a wall of the muff (10), further a free end of the temperature sensor (20), or a temperature sensor segment (56), is configured near said sensor's free end being guided within and/or through said feedthrough when the muff (10; 10a) has been slipped onto the material feed pipe (32).

2. Hot runner nozzle (30) as claimed in claim 1, characterized in that the material feed pipe (32) is made of steel.

3. Hot runner nozzle (30) as claimed in claim 1, characterized in that the muff (10; 10a) is made of copper or a copper alloy.

4. Hot runner nozzle (30) as claimed in claim 1, characterized in that at least one groove (12; 18) is fitted into and along an outside surface (14) of the muff (10; 10a) and receives the heater (16) and/or the temperature sensor (20).

5. Hot runner nozzle (30) as claimed in claim 4, characterized in that the heater (16) and/or the temperature sensor (20) is/are configured in the minimum of one groove (12; 18) by press-fitting.

6. Hot runner nozzle (30) as claimed in claim 4, characterized in that a groove (12) for the heater (16) and a further groove (18) for the temperature sensor (20) are subtended in the outside surface (14) of the muff (10; 10a)

7. Hot runner nozzle (30) as claimed in claim 1, characterized in that the feedthrough (24) is fitted at the outside surface (14) of the muff (10) with a groove-like or slot-shaped extension (26, 26a) designed in a manner that the free end of the temperature sensor (20) can be affixed within said extension.

8. Hot runner nozzle (30) as claimed in claim 1, characterized in that one free end of the temperature sensor (20) enters the feedthrough (24) in defined manner.

9. Hot runner nozzle (30) as claimed in claim 8, characterized in that the free end of the temperature sensor (20) is affixed by a fastener in a manner that, in its assembled state, contact is assured between the free temperature sensor's free end and the material feed pipe (32).

10. Hot runner nozzle (30) as claimed in claim 9, characterized in that the fastener is a clamp (27) made of a temperature-resistant spring steel.

11. Hot runner nozzle as claimed in claim 1, characterized in that a recess receiving the temperature sensor's free end is subtended at an outside surface of the material feed pipe (32) and/or at a muff inside surface, said recess communicating with the feedthrough when the muff has been slipped onto the material feed pipe.

12. Hot runner nozzle as claimed in claim 11, characterized in that the recess is designed in a manner that the temperature sensor's free end can be affixed in it.
